(19) United States
(12) Patent Application Publication
(10) Pub. No.: US 2013/0270815 A1
(43) Pub. Date: Oct. 17, 2013

(54) FLUID CONDUIT SYSTEMS AND APPARATUS

(71) Applicant: Heliofocus Ltd., (US)

(72) Inventors: HAIM BRUDO, KIBBUTZ GIVAT BRENER (IL); HAGAY CAFRI, BET-HASHMONAY (IL); YANIR BLUMENTHAL, KFAR SABA (IL)

(21) Appl. No.: 13/859,754

(22) Filed: Apr. 10, 2013

Related U.S. Application Data
(60) Provisional application No. 61/622,035, filed on Apr. 10, 2012.
(60) Provisional application No. 61/622,038, filed on Apr. 10, 2012.
(60) Provisional application No. 61/622,040, filed on Apr. 10, 2012.
(60) Provisional application No. 61/622,045, filed on Apr. 10, 2012.

(51) Int. Cl. F16L 37/56

(52) U.S. Cl. CPC F16L 37/565
USPC 285/123.1

(57) ABSTRACT

A fluid conduit system comprising a first portion including a central pipe and a circumferential pipe surrounding the central pipe and coaxially aligned with the central pipe along a radial axis thereof, a second portion including a central pipe and a circumferential pipe surrounding the central pipe along the radial axis, the first portion being aligned with the second portion in the radial axis, and a tube configured for housing the central pipe of the first portion and the central pipe of the second portion therein, at a longitudinal distance between the central pipe of the first portion and the central pipe of the second portion, along a longitudinal axis thereof.

### CROSS REFERENCE TO RELATED APPLICATIONS

This application claims the benefit of priority from U.S. Provisional Patent Application No. 61/622,035, filed on Apr. 10, 2012, titled “Coaxial Pipe Coupling Assembly”; U.S. Provisional Patent Application No. 61/622,038, filed on Apr. 10, 2012, titled “Pipe Adjoining Assembly”; U.S. Provisional Patent Application No. 61/622,040, filed on Apr. 10, 2012, titled “Flexible Pipe Assembly”; and U.S. Provisional Patent Application No. 61622045, filed on Apr. 10, 2012, titled “Sensor Assembly”, are of which applications are incorporated herein by reference in their entirety.

### FIELD OF THE INVENTION

The present invention relates generally to fluid conduit systems and apparatus.

### BACKGROUND OF THE INVENTION

Fluid conduit systems comprise a plurality of pipes designed for flow of fluids therein.

The plurality of pipes may be designed as an annulus assembly comprising a central fluid channel, surrounded by a circumferential fluid channel. The central fluid channel and the circumferential fluid channel may be generally coaxially aligned therebetween.

### SUMMARY OF THE INVENTION

There is thus provided in accordance with an embodiment of the disclosure, a fluid conduit system comprising a first portion including a central pipe and a circumferential pipe surrounding the central pipe and coaxially aligned with the central pipe along a radial axis thereof, a second portion including a central pipe and a circumferential pipe surrounding the central pipe along the radial axis, the first portion being aligned with the second portion in the radial axis, and a tube configured for housing the central pipe of the first portion and the central pipe of the second portion therein, at a longitudinal distance between the central pipe of the first portion and the central pipe of the second portion, along a longitudinal axis thereof.

In accordance with an embodiment, the tube may be surrounded by a sealing element. The sealing element may comprise a cord. The cord may be formed with a substantially rectangular cross section. A working fluid may flow within the central pipe of at least one of the first portion and second portion, at a first temperature, and the working fluid may flow within the circumferential pipe of at least one of the first portion and second portion, at a second temperature, and the first temperature may be different than the second temperature. The first temperature may be higher than the second temperature and the central pipe of at least one of the first portion and second portion may thermally expand along the longitudinal distance.

In accordance with an embodiment, the central pipe of at least one of the first portion and second portion thermally expands to a different degree than the thermal expansion of the circumferential pipe of at least one of the first portion and second portion. The central pipe of the second portion may be slidably inserted within the tube.

In accordance with an embodiment, the fluid conduit system may further comprise a thermal insulation layer intermediate the central pipe and the circumferential pipe.

In accordance with another embodiment, the central pipe may be formed of a thermal insulating layer.

In accordance with an embodiment, the first portion and the second portion are connected thereto by a connection configured for repeated assembling and disassembling of the connection.

In accordance with an embodiment, a flexible connecting element may connect the central pipe to the circumferential pipe. The flexible connecting element may comprise at least one spring element.

There is thus provided in accordance with an embodiment of the disclosure a fluid conduit system comprising a central pipe and a circumferential pipe surrounding the central pipe and coaxially aligned with the central pipe along a radial axis thereof, a tube configured for housing at least a portion of a device therein and wherein the tube is placed intermediate the central pipe and the circumferential pipe, the tube being configured for flexibly extending along the radial axis. The tube may comprise a cylindrical sheath formed as a braided sheath. The tube may be formed of a material with a material flexibility comprising a minimum bend radius in the range of approximately 0.2-70 inches. The device may comprise a sensor.

In accordance with an embodiment, a working fluid may flow within the central pipe at a first temperature and the working fluid may flow within the circumferential pipe at a second temperature, and the first temperature may be different than the second temperature. The first temperature may be higher than the second temperature. The central pipe may thermally expand to a different degree than the thermal expansion of the circumferential pipe.

In accordance with an embodiment, the fluid conduit system may further comprise a thermal insulation layer intermediate the central pipe and the circumferential pipe.

In accordance with another embodiment, the central pipe may be formed of a thermal insulating layer.

There is thus provided in accordance with an embodiment of the disclosure a fluid conduit system comprising a first portion comprising a central pipe and a circumferential pipe surrounding the central pipe and coaxially aligned with the central pipe along a radial axis thereof, a second portion comprising a central pipe and a circumferential pipe surrounding the central pipe along a radial axis thereof, the first portion being unparallel to the second portion along a longitudinal axis of the first portion, the central pipe of the second portion including a tube configured for flexibly extending along the radial axis and/or the longitudinal axis of the tube.

In accordance with an embodiment, the first portion may be substantially perpendicular to the second portion. The tube may comprise a cylindrical sheath formed as a braided sheath. The tube may be formed of a material with a material flexibility comprising a minimum bend radius in the range of approximately 0.2-70 inches.

### BRIEF DESCRIPTION OF THE DRAWINGS

The present invention will be understood and appreciated more fully from the following detailed description, taken in conjunction with the drawings in which:

FIGS. 1A-1D are simplified sectional illustrations of a fluid conduit system according to an embodiment of the present disclosure at a first, second, third and fourth assembly step, respectively;

FIG. 2 is a simplified sectional illustration of a pipe adjoining assembly used with the fluid conduit system of FIGS. 1A-1D;

FIGS. 3A-3C are simplified sectional illustrations of a fluid conduit system according to another embodiment of the present disclosure at a first, second and third assembly step, respectively;

FIG. 4 is a simplified sectional illustration of a fluid conduit system comprising a coaxial pipe coupling assembly according to an embodiment of the present disclosure, taken at lines IV-IV in FIG. 1D;

FIG. 5 is a simplified pictorial illustration of a fluid conduit system comprising a coaxial pipe coupling assembly according to another embodiment of the present disclosure;

FIG. 6 is a simplified sectional illustration of a fluid conduit system comprising a flexible housing assembly according to an embodiment of the present disclosure;

FIG. 7 is a simplified pictorial illustration of the flexible housing assembly of FIG. 6 according to another embodiment of the present disclosure; and

FIG. 8 is a simplified sectional illustration of a fluid conduit system comprising a flexible pipe assembly according to an embodiment of the present disclosure.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

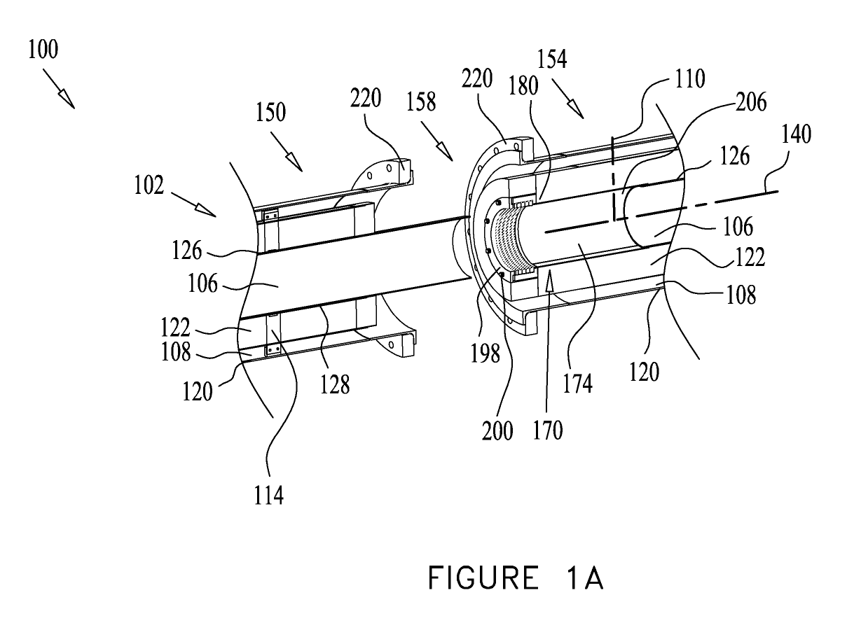

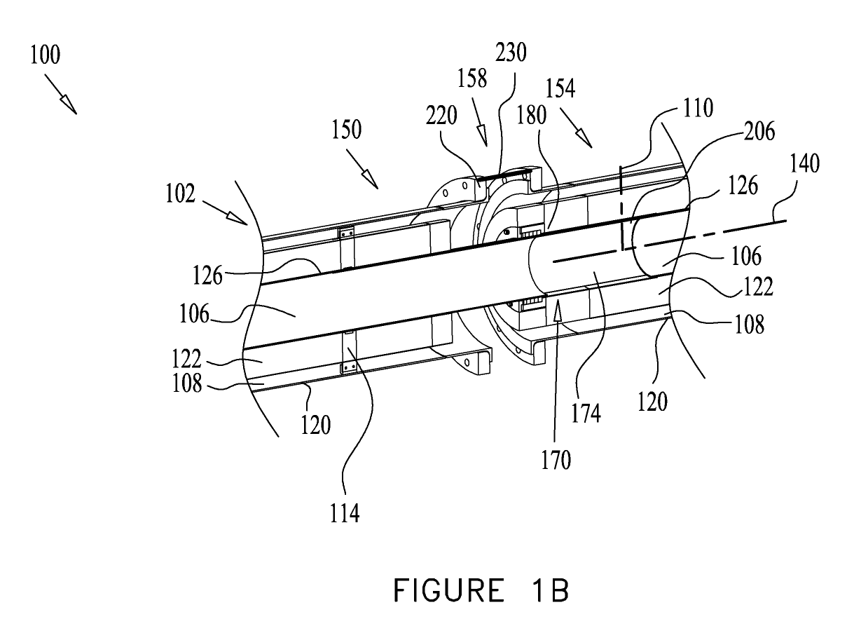

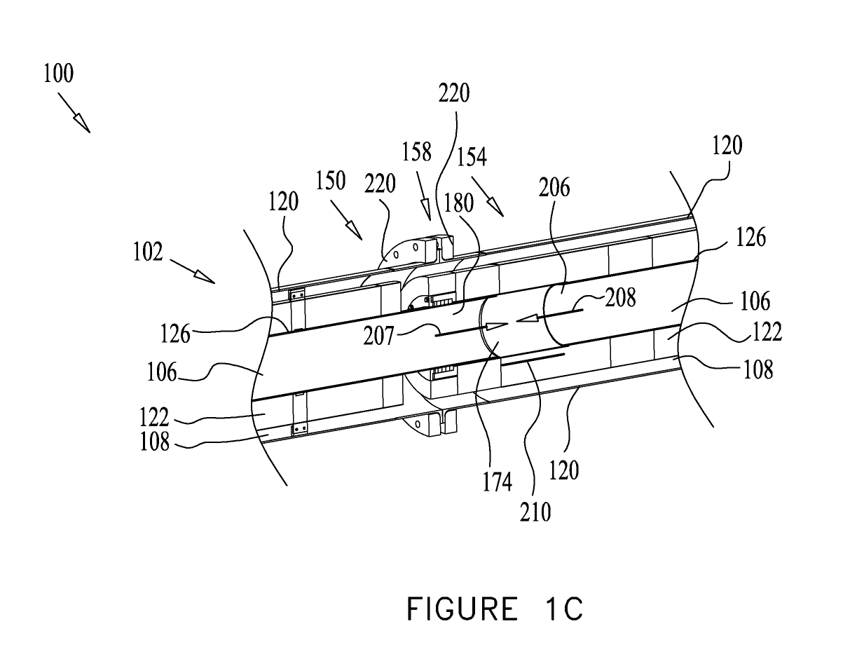

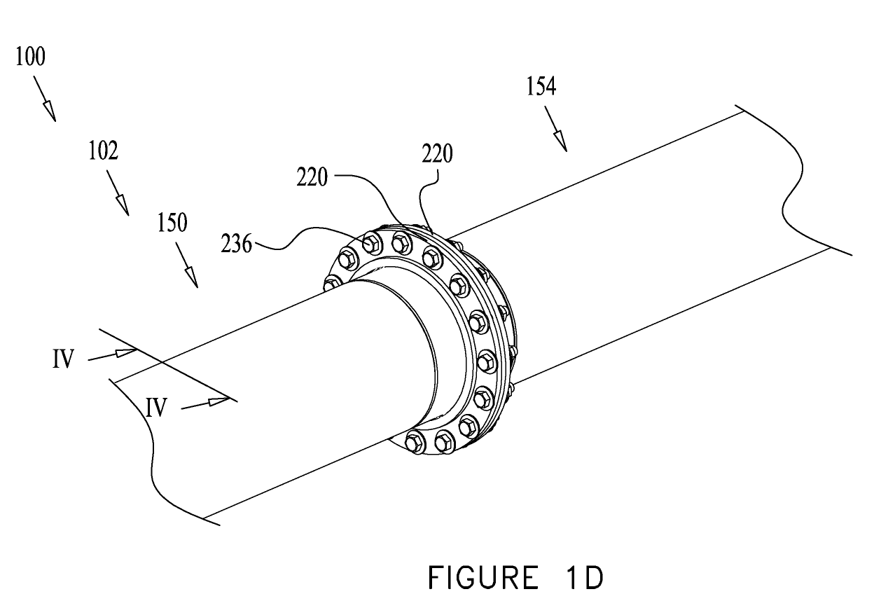

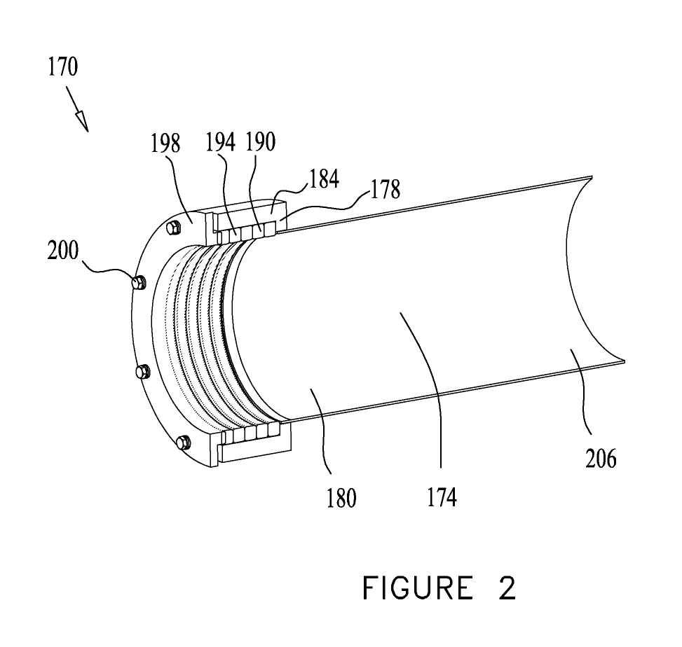

FIGS. 1A-1D and 2 are simplified sectional illustrations of a fluid conduit system according to an embodiment of the present disclosure at a first, second, third and fourth assembly step and a simplified sectional illustration of a pipe adjoining assembly, respectively. As seen in FIG. 1A, a fluid conduit system 100 comprises an annulus assembly 102. The annulus assembly 102 comprises a central fluid channel 106, surrounded by a circumferential fluid channel 108. The central fluid channel 106 and the circumferential fluid channel 108 may be generally coaxially aligned therebetween along a radial axis 110. The central fluid channel 106 and the circumferential fluid channel 108 may be provided for flow of a working fluid therethrough.

The coaxial alignment between the central fluid channel 106 and the circumferential fluid channel 108 in the radial axis 110 may be substantially maintained in any suitable manner. For example, aligners 114 may be provided between the central fluid channel 106 and the circumferential fluid channel 108.

A circumferential pipe 120 may be provided around the circumferential fluid channel 108. The circumferential pipe 120 may be formed of any suitable material allowing relatively high temperature fluid to flow therethrough, such as in a range of approximately 100-400 C°. In a non-limiting example, the circumferential pipe 120 may be formed of carbon steel.

A central thermal insulation layer 122 may be provided between the central fluid channel 106 and the circumferential fluid channel 108 for thermally insulating the working fluid flowing through the central fluid channel 106 and preventing heat exchange between the working fluid flowing within the central fluid channel 106, generally at a first temperature and the working fluid flowing within the circumferential fluid channel 108, generally at a second temperature.

In accordance with an embodiment, a central pipe 126 may be provided around the central fluid channel 106. The central pipe 126 may underlie the central thermal insulation layer 122, as seen in FIGS. 1A-1C, or may overlie the central thermal insulation layer 122. The central pipe 126 may be formed of any suitable material allowing relatively high temperature fluid to flow therethrough, such as in a range of approximately 150-1000 C°. In a non-limiting example, the central pipe 126 may be formed of carbon steel or stainless steel.

In accordance with another embodiment, the central pipe 126 may be formed of the central thermal insulation layer 122, such that the working fluid may flow in direct contact with an inner interior surface 128 of the central thermal insulation layer 122.

A circumferential thermal insulation layer (not shown) may be provided to insulate the working fluid from the ambient environment out of the annulus assembly 102.

The central thermal insulation layer 122 and the circumferential thermal insulation layer may be formed of any suitable insulating material, such as a microporous insulator or any suitable ceramic material, or multiple layers of different materials, for example.

The working fluid may comprise any suitable fluid, such as a gas, typically air, helium or carbon dioxide, or a liquid such as oil, water, an organic fluid or molten salt, for example.

In some embodiments, the working fluid may flow within the central fluid channel 106 at the first temperature and within the circumferential fluid channel 108 at the second temperature. The first temperature may be higher than the second temperature. In a non-limiting example, the first temperature may be in the range of approximately 200-1000° C.

In another non-limiting example, the first temperature may be in the range of approximately 400-1000° C. In yet another non-limiting example, the first temperature may be in the range of approximately 400-800° C. In a non-limiting example, the second temperature may be in the range of approximately 25-350° C. In another non-limiting example, the second temperature may be in the range of approximately 100-350° C. In yet another non-limiting example, the second temperature may be in the range of approximately 150-350° C.

The working fluid may be heated by a thermal energy source (not shown) to the first temperature, prior to entering the annulus assembly 102. The thermal energy source may be any source suitable for heating the working fluid to the first temperature. In a non-limiting example, the thermal energy source may comprise a fossil-fuel system, a renewable energy system, such as a geothermal energy system, a wind energy system, a wave energy system, or a solar energy system.

The working fluid may flow from the thermal energy source to the central fluid channel 106 at the first temperature.

Thermal energy of the working fluid may be provided to a thermal energy consumption system (not shown) for operation thereof, generally at the first temperature. The thermal energy consumption system may comprise any thermal energy consumption system utilizing the working fluid, such as, for example, a steam turbine, a vapor turbine, a gas turbine, an industrial system, a vapor consuming process used in the chemical industry or other industries, a dryer, a solid desiccant system, or an absorption refrigerator.

The thermal energy of the working fluid may be provided to the thermal energy consumption system in any suitable manner, such as by a heat exchanger assembly (not shown) or any other suitable device for providing the working fluid thermal energy to the thermal energy consumption system.

Following provision of the thermal energy of the working fluid to the thermal energy consumption system the temperature of the working fluid may drop to the second temperature. The working fluid at the second temperature may be directed to flow into the circumferential fluid channel 108. The working fluid may flow back to the thermal energy source for reheating thereof or may be directed to any other suitable location.

The working fluid at the first temperature may flow within the central fluid channel 106 in an opposite direction than the working fluid at the second temperature flowing within the circumferential fluid channel 108. Alternatively, the working fluid at the first temperature may flow within the central fluid channel 106 in the same direction of the working fluid at the second temperature flowing within the circumferential fluid channel 108.

Due to the relatively high first temperature of the working fluid flowing within the central fluid channel 106, the central pipe 126 may thermally expand along a longitudinal axis 140. Similarly the central pipe 126 may thermally expand along the radial axis 110.

Since the working fluid flowing within the central fluid channel 106 at the first temperature may be significantly hotter than the working fluid flowing within the circumferential fluid channel 108 at the second temperature, the central pipe 126 may thermally expand to a greater degree than the circumferential pipe 120 along the longitudinal axis 140 and/or the radial axis 110.

In accordance with another embodiment, such as wherein the second temperature is higher than the first temperature, the central pipe 126 may thermally expand to a different degree than the circumferential pipe 120 along the longitudinal axis 140 and/or the radial axis 110.

The annulus assembly 102 may be formed of a plurality of portions adjoining thereto at junctions. In FIGS. 1A-1D a first portion 150 is shown adjoining a second portion 154 at a junction 158. Both first and second portions 150 and 154 comprise the central fluid channel 106 including the central pipe 126 and the circumferential fluid channel 108 including the circumferential pipe 120, and may additionally comprise the central thermal insulation layer 122 and/or the circumferential thermal insulation layer.

At junction 158 the first portion may be adjoined to the second portion by a pipe adjoining assembly 170, which is shown without the annulus assembly 102 in FIG. 2 and shown enlarged.

In the embodiment shown in FIG. 2, the pipe adjoining assembly 170 may comprise a tube 174 formed of any suitable material allowing relatively high temperature fluid to flow therethrough, such as in a range of approximately 150-1000 C°. In a non-limiting example, the tube 174 may be formed of carbon steel or stainless steel.

The tube 174 may be attached to a sealant housing 178 formed at an end 180 of the tube 175 proximal to the junction 158. The sealant housing 178 may be formed of any suitable material, such as carbon steel or stainless steel, for example. The sealant housing 178 may peripherally surround the tube 174. The sealant housing 178 may be formed with a substantially L-like shaped cross section 184 or any other suitable shape for housing any suitable sealing element. In the embodiment of FIG. 2, the sealing element comprises a cord 190. The cord 190 may be configured in any suitable configuration, such as with a circular cross section, for example, or a rectangular cross section 194, as seen in FIG. 2. The cord 190 with the rectangular cross section 194 may be fittingly housed within the sealant housing 178.

The cord 190 may be formed of any suitable material, such as a deformable material so as to allow the cord 190 to be pressed between the pipe adjoining assembly 170 and the central pipe 126 of the first portion 150, as shown in FIG. 1C. The cord 190 may be formed of a ceramic material. In a non-limiting example, the cord 190 may comprise a braided ceramic rope, such as a Square Braid CeraTex Ceramic Fiber Rope commercially available at Ceramic Fiber.Net of Mineral Seal Corp. 1832 S. Research Loop Tucson, Ariz., USA.

The sealing element is provided for securely engaging the central pipe 126 of the first portion 150 to the pipe adjoining assembly 170, as seen in FIG. 1B, while allowing the central pipe 126 to slide along the longitudinal axis 140 into tube 174, as seen in FIG. 1C.

In another embodiment, the sealing element may be obviated. In yet another embodiment any means for engaging the central pipe 126 of the first portion 150 to the pipe adjoin assembly 170 may be used, such as screws or bolts, for example.

A ring 198 may be provided to overlie the cord 190 and the sealant housing 178. A plurality of bolts 200 or any other attaching means may be provided peripherally around the ring 198. The bolts 200 may be inserted into corresponding bores (not shown) formed in the sealant housing 178.

As seen in FIG. 1C, the tube 174 may be designed to house the central pipe 126 of the first portion 150 at end 180 thereof and the central pipe 126 of the second portion 154 at an end 206 thereof. End 206 of tube 174 is at the opposite side of end 180 and is distal to junction 158.

The central pipe 126 of the first portion 150 may be placed in tube 174 at a distance 210 from the central pipe 126 of the second portion 154. When working fluid flows in the central fluid channel 106 at the relatively high, first temperature, the central pipe 126 of the first portion 150 may thermally expand along the longitudinal axis 140 towards the central pipe 126 of the second portion 154 in the orientation of an arrow 207. Similarly, the central pipe 126 of the second portion 154 may thermally expand along the longitudinal axis 140 towards the central pipe 126 of the first portion 150 in the orientation of an arrow 208. The distance 210 is provided to allow the each of the central pipes 126 of the first and second portions 150 and 154 to thermally expand within the tube 174.

As described above, the central pipe 126 may thermally expand to a greater degree than the circumferential pipe 120 along the longitudinal axis 140. The distance 210 allows the central pipes 126 of the first and second portions 150 and 154 to thermally expand within the tube 174, without requiring any movement or adaptation of the circumferential pipes 120 of the first and second portions 150 and 154.

The central pipes 126 of the first and second portions 150 and 154 may be placed within the tube 174 in any suitable manner and the first portion 150 may be adjoined with the second portion 154 in any suitable manner. Exemplary first, second, third and fourth assembly steps are shown in respective FIGS. 1A-1D.

As seen in FIG. 1A, initially the first portion 150 is disconnected from the second portion 154. An annular flange 220 may extend from both the circumferential pipes 120 of the first and second portions 150 and 154, at the ends 180 thereof, which is proximal to junction 158. The annular flange 220 of the first portion 150 is initially disconnected from the annular flange 220 of the second portion 154. The central pipe 126 of the second portion 154 is seated within the tube 174 at the end 206. The bolts 200 are loosely inserted in ring 198 and corresponding bores of sealant housing 178.

Turning to FIG. 1B, at a second assembly step, the central pipe 126 of the first portion 150 is slidably inserted into the pipe adjoining assembly 170 until the distance 210 from the central pipe 126 of the second portion 154 is reached (as shown in FIG. 1C). The annular flange 220 of the first portion 150 is closer to the annular flange 220 of the second portion 154 yet a gap 230 is formed therebetween. The gap 230 allows an operator to readily access the bolts 200 manually or in any other suitable manner.

The operator may tighten the bolts 200 for fixing the ring 198 to the sealant housing 178. In turn, the sealing element, such as the cord 190, presses upon the central pipe 126 of the first portion 150, thereby securing the central pipe 126 of the first portion 150 within the pipe adjoining assembly 170.

The operator may thereafter slide the annular flange 220 of the first portion 150 towards the annular flange 220 of the second portion 154, as seen in FIG. 1C. The annular flange 220 of the first portion 150 may be fixed to annular flange 220 of the second portion 154 by any suitable means, such as bolts 236 for adjoining first portion 150 to the second portion 154, as seen in FIG. 1D.

Thus it is shown that the annulus assembly 102, comprising the pipe adjoining assembly 170, forms a continuous central fluid channel 106 with space for thermal expansion of the central pipes 126 of the first and second portions 150 and 154, along distance 210, within the tube 174 of the pipe adjoining assembly 170. The distance 210 may comprise any required length for allowing the central pipes 126 of the first and second portions 150 and 154 to thermally expand.

Additionally, the pipe adjoining assembly 170 allows for maintaining the annulus assembly configuration (i.e. central pipe 126 coaxially aligned with circumferential pipe 120) at the junctions.

Moreover, depending on parameters, such as the first temperature or the material of the central pipes 126, there may be various degrees of thermal expansion of the central pipes 126. For example, the central pipe 126 of the first portion 150 may thermally expand to a lesser degree, wherein the first temperature is low, than a greater thermal expansion degree, wherein the first temperature is high. In accordance with an embodiment, the distance 210 is designed to be sufficient for various thermal expansion degrees, without requiring adjustment of the distance 210 for each degree of thermal expansion. For example, the distance 210 may be designed with a length of a meter, thereby being sufficient for allowing various degrees of thermal expansions of the central pipes 126, from a few millimeters to tens of centimeters.

Additionally, the connection between the first portion 150 and the second portion 154 is configured for repeated assembling and disassembling thereof. This may be provided by annular flanges 220 or by any other suitable means. Furthermore, gap 230 formed between annular flanges 220, allows an operator to readily access the bolts 200 for disjoining the first portion 150 from the second portion 154. Accessibility to junctions along the annulus assembly 102, such as junction 158, is advantageous as it allows performing repair and maintenance operations to designated portions of the annulus assembly 102, without having to disassemble the whole annulus assembly 102. This is particularity advantageous wherein the annulus assembly 102 is relatively long, such as hundreds of meters long. For disjoining the first portion 150 from the second portion 154 an operator may unfasten bolts 236 (FIG. 1C) and move away the circumferential pipe 120 of the first portion 150 from the circumferential pipe 120 of the second portion 154 (FIG. 1B). The operator may accesses the ring 198, via gap 230, for unfastening bolts 200. The central pipe 126 of the first portion 150 may be slidably removed from the central pipe 126 of the second portion 154 (FIG. 1A).

It is noted that in FIGS. 1A-1C the pipe adjoining assembly 170 is shown placed at the second portion 154 and the first portion 150 being slidably engaged therewith. Alternatively, the pipe adjoining assembly 170 may be placed at the first portion 150 and the second portion 154 may be slidably engaged therewith.

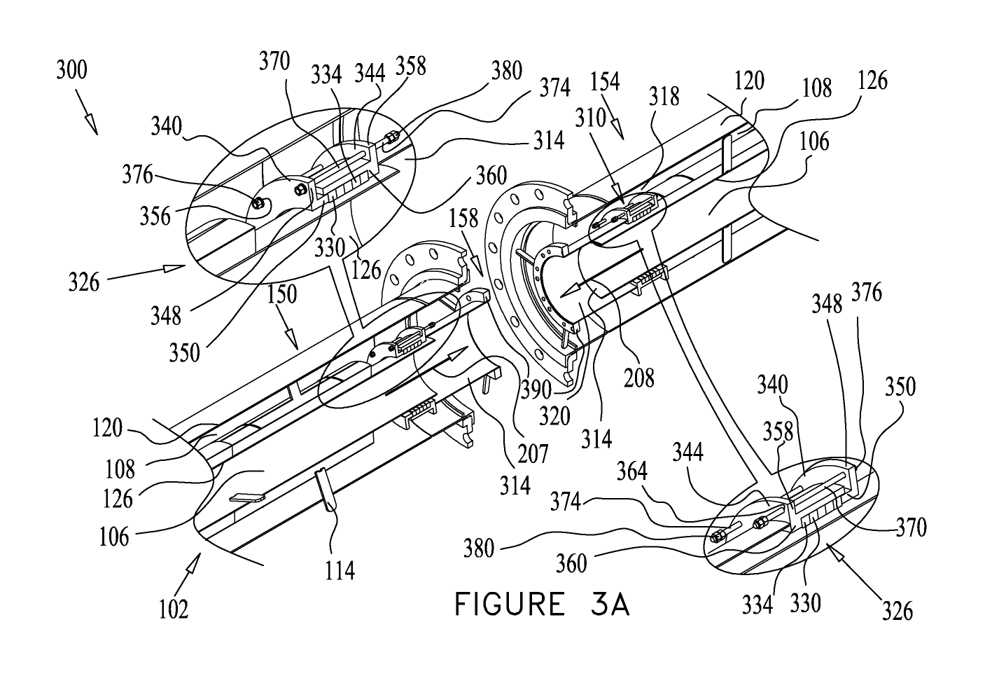

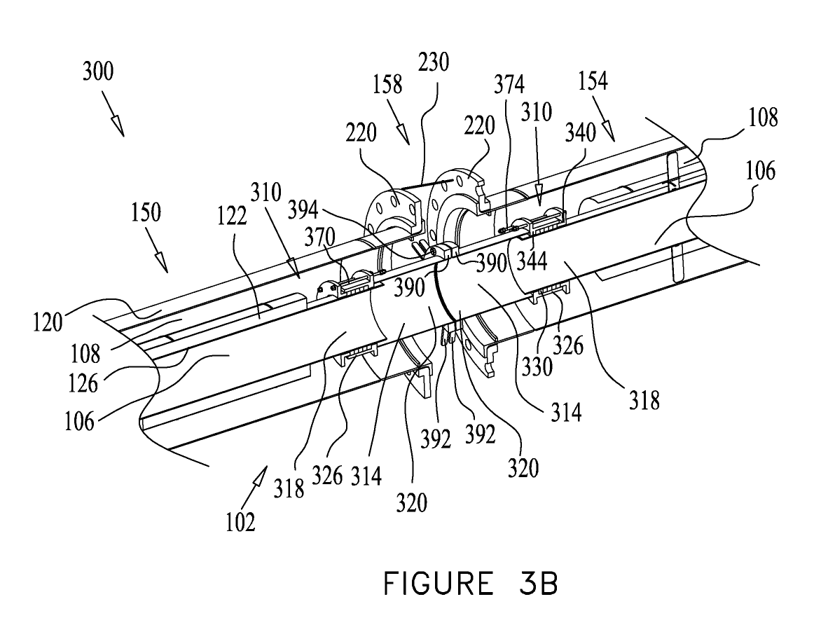

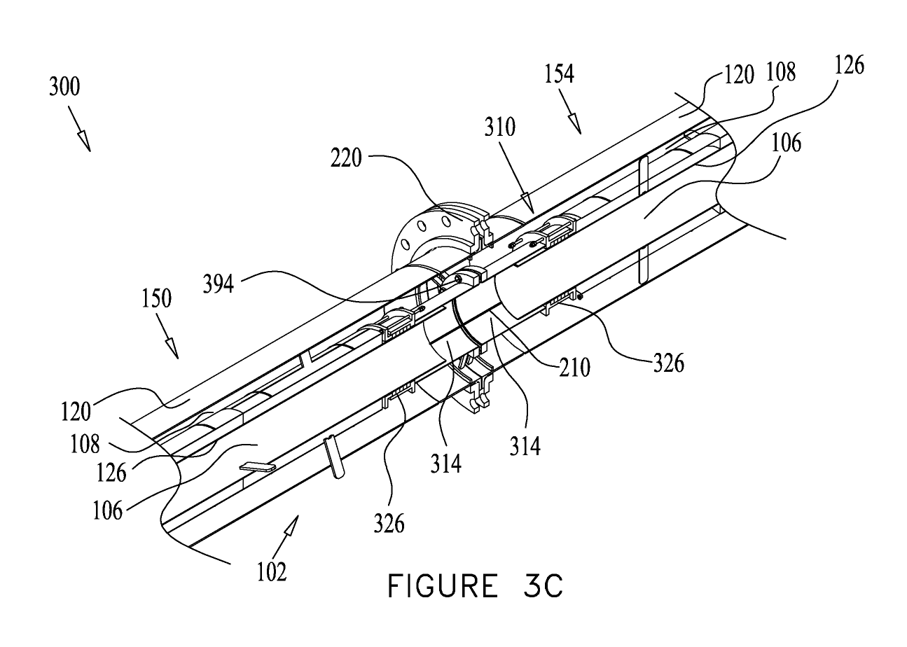

In the embodiment of FIGS. 1A-1D, the annulus assembly 102 comprises a single pipe adjoining assembly 170. In other embodiments, more than one pipe adjoining assembly 170 may be provided, such as shown in FIGS. 3A-3C.

The pipe adjoining assembly 170 may be configured in any suitable manner for adjoining portions of the central pipe 126 to each other with a distance therebetween for allowing thermal expansion along the longitudinal axis 140.

In FIGS. 3A-3C, there is shown a fluid conduit system 300 comprising the annulus assembly 102 of FIGS. 1A-1D with a pipe adjoining assembly 310.

In the embodiment shown in FIGS. 3A-3C each of respective first and second portions 150 and 154 are provided with a pipe adjoining assembly 310, though it is appreciated that just one of the pipe adjoining assemblies 310 may be provided.

The pipe adjoining assembly 310 comprises a tube 314, similar to tube 174 of FIGS. 1A-2. At an end 318 thereof there is provided a sealant housing 326. End 318 of tube 314 is distal to junction 158 and is at the opposite side of an end 320, which is proximal to junction 158. The sealant housing 326 may be formed of any suitable material, such as carbon steel or stainless steel, for example. The sealant housing 326 may peripherally surround the tube 314.

As seen in the inserts in FIG. 1A, the sealant housing 326 may comprise a cord 330 which presses upon the central pipe 126 so as to ensure that the central pipe 126 is tightly engaged with the tube 314.

Cord 330 may be configured in any suitable configuration and may be formed of any suitable deformable material so as to allow the cord 330 to press upon the central pipe 126. For example, the deformable material may be a ceramic material, for example, and may be a Square Braid CeraTex Ceramic Fiber Rope commercially available at Ceramic Fiber.Net of Mineral Seal Corp. 1832 S. Research Loop Tucson, Ariz., USA.

The cord 330 may be configured in any suitable configuration, such as with a circular cross section, for example, or a rectangular cross section 334. The cord 330 with the rectangular cross section 334 may be fittingly housed within the sealant housing 326.

The cord 330 may be mounted in any suitable manner. The cord 330 may be placed intermediate a lower flange 340 and an upper flange 344 of the sealant housing 326. Upper flange 344 may overlie the cord 330 and partially overlie the lower flange 340. The lower flange 340 may be formed with a peripheral protrusion 348 protruding from a cylindrical portion 350 thereof. The peripheral protrusion 348 may be formed with a plurality of peripherally arranged bores 356. The upper flange 344 may be formed with a peripheral protrusion 358 protruding from a cylindrical portion 360 thereof. The peripheral protrusion 358 may be formed with a plurality of peripherally arranged bores 364.

The upper flange 344 may be harnessed to the tube 314 in any suitable manner. Bolts 370, or any suitable fasteners, may be inserted within bore 356 of the peripheral protrusion 348 and within bore 364 of the peripheral protrusion 358.

Fastening the bolt 370 to the peripheral protrusion 348 and the peripheral protrusion 358 may be performed in any suitable manner. The bolt 370 may be formed with a proximal portion 374 extending out of the bores 364 proximal to junction 158. A distal portion 376 extending out of the bores 356 is provided relatively distal to junction 158.

At first portion 150, by pulling the proximal portion 374 in the orientation of arrow 207 and tightening nuts 380 thereon, the upper flange 344 presses upon the lower flange 340, which in turn presses upon the cord 330. The cord 330 presses the central pipe 126 so as to ensure that the central pipe 126 is tightly engaged with the tube 314.

Similarly, at second portion 154, by pulling the proximal portion 374 in the orientation of arrow 208 and tightening nuts 380 thereon, the upper flange 344 presses upon the lower flange 340, which in turn presses upon the cord 330. The cord 330 presses the central pipe 126 so as to ensure that the central pipe 126 is tightly engaged with the tube 314.

The first portion 150 may be adjoined with the second portion 154, via the pipe adjoining assembly 310, in any suitable manner. Exemplary first, second and third assembly steps are shown in respective FIGS. 3A-3C.

As seen in FIG. 3A, initially the first portion 150 is disconnected from the second portion 154. An annular flange 390 may extend from both the central pipes 126 of the first and second portions 150 and 154, at the ends 320 thereof. The annular flanges 220 and 390 of the first portion 150 are disconnected from the annular flanges 220 and 390 of the second portion 154. The bolt 370 of the pipe adjoining assembly 310 of the first portion 150 and the second portion 154 is loosely inserted in bores 356 and 364.

Turning to FIG. 3B, at a second assembly step, the annular flange 390 of the first portion 150 may be slid towards the annular flange 390 of the second portion 154 until it reaches the distance 210 (FIG. 3C). Guides 392 may protrude from the annular flange 390 and may aid the operator in sliding the annular flange 390 of the first portion 150 towards the annular flange 390 of the second portion 154. Thereafter, the annular flange 390 of the first portion 150 may be fixed to annular flange 390 of the second portion 154 by any suitable means, such as bolts 394. The annular flange 220 of the first portion 150 is closer to the annular flange 220 of the second portion 154 yet the gap 230 is formed therebetween. The gap 230 allows an operator to readily access the bolts 394 manually or in any other suitable manner.

The operator may tighten the bolts 370 of each of the first and second portions 150 and 154, at the proximal portion 374 thereof for fixing the lower flange 340 to the upper flange 344. In turn, the sealing element, such as the cord 330, presses upon the central pipe 126, thereby securing the central pipe 126 within the pipe adjoining assembly 310.

The operator may thereafter slide the annular flange 220 of the first portion 150 towards the annular flange 220 of the second portion 154, as seen in FIG. 3C. The annular flange 220 of the first portion 150 may be fixed to annular flange 220 of the second portion 154 by bolts 236 for adjoining first portion 150 to the second portion 154, similarly as seen in FIG. 1D.

Thus it is shown that the annulus assembly 102 comprising the pipe adjoining assembly 310 forms a continuous central fluid channel 106 with space for thermal expansion of the central pipes 126 of the first and second portions 150 and 154 along distance 210 within the tubes 314 of the pipe adjoining assemblies 310. The distance 210 may comprise any required length for allowing the central pipes 126 of the first and second portions 150 and 154 to thermally expand.

Additionally, the pipe adjoining assembly 310 allows for maintaining the annulus assembly configuration (i.e. central pipe 126 coaxially aligned with circumferential pipe 120) at the junctions.

Moreover, depending on parameters, such as the first temperature or the material of the central pipes 126, there may be various degrees of thermal expansion of the central pipes 126. For example, the central pipe 126 of the first portion 150 may thermally expand to a lesser degree wherein the first temperature is low, than a greater thermal expansion degree wherein the first temperature is high. In accordance with an embodiment, the distance 210 is designed to be sufficient for various thermal expansion degrees, without requiring adjustment of the distance 210 for each degree of thermal expansion. For example, the distance 210 may be designed with a length of a meter, thereby being sufficient for allowing various degrees of thermal expansions of the central pipes 126, from a few millimeters to tens of centimeters.

Additionally, the connection between the first portion 150 and the second portion 154 is configured for repeated assembling and disassembling thereof. This may be provided by annular flanges 220 and 390 or by any other suitable means. Furthermore, as described above, gap 230 allows an operator to readily access the bolts 394 for disjoining the first portion 150 from the second portion 154. Accessibility to junctions along the annulus assembly 102, such as junction 158, is advantageous as it allows performing repair and maintenance operations to designated portions of the annulus assembly 102, without having to disassemble the whole annulus assembly 102. This is particularity advantageous wherein the annulus assembly 102 is relatively long, such as hundreds of meters long. For disjoining the first portion 150 from the second portion 154 an operator may unfasten bolts 236 (FIG. 3C) and move away the circumferential pipe 120 of the first portion 150 from the circumferential pipe 120 of the second portion 154 (FIG. 3B). The operator may accesses the annular flange 390, via gap 230, for unfastening bolts 394. The central pipe 126 of the first portion 150 may be slidably removed from the central pipe 126 of the second portion 154 (FIG. 3A).

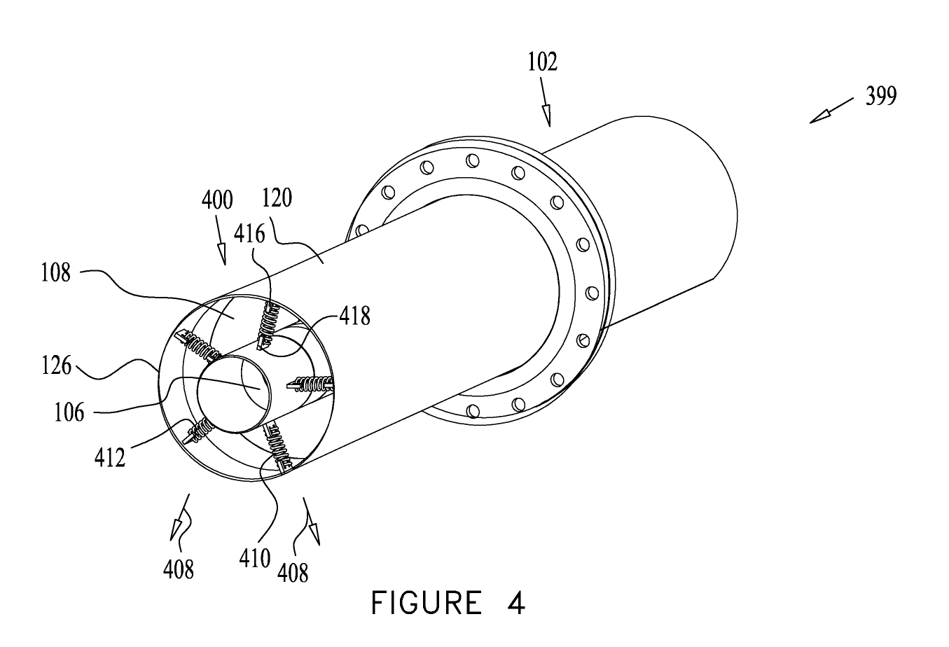

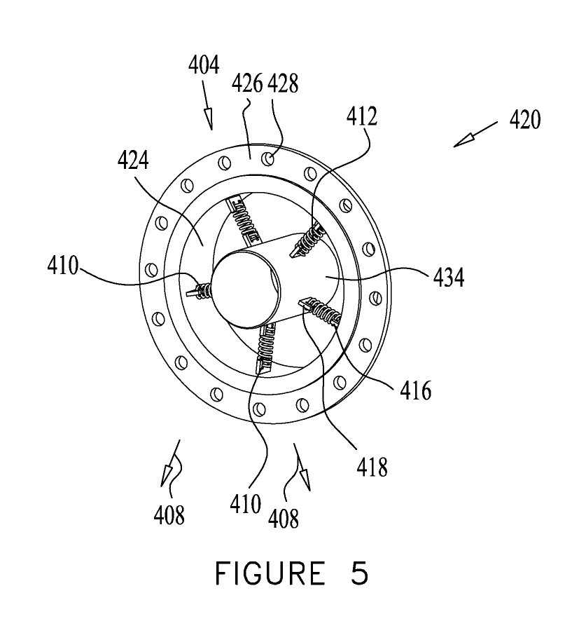

FIG. 4 is a simplified sectional illustration of a fluid conduit system 399 comprising a coaxial pipe coupling assembly 400 according to an embodiment of the present disclosure, taken at lines IV-IV in FIG. 1D. FIG. 5 is a simplified pictorial illustration of a coaxial pipe coupling assembly 404 according to an embodiment of the present disclosure.

As described above, the central pipe 126 may thermally expand along the radial axis 110 in the orientation of an arrow 408. The central pipe 126 may thermally expand to a greater degree than the circumferential pipe 120.

In accordance with another embodiment, the central pipe 126 may thermally expand to a different degree than the circumferential pipe 120 along the longitudinal axis 140 and/or the radial axis 110.

The coaxial pipe coupling assembly 400 may comprise a connecting element 410. The connecting element 410 may be provided intermediate the central pipe 126 and the circumferential pipe 120 to ensure the coaxial alignment therebetween is substantially maintained, also wherein the extent of thermal expansion of the central pipe 126 is not the same extent of thermal expansion of the circumferential pipe 120.

The connecting element 410 may be a flexible connecting element. In accordance with an embodiment, the flexible connecting element may comprise a spring element or a plurality of spring elements 412 spaced apart from each other in the radial orientation of arrow 408.

The spring elements 412 may comprise any suitable spring, such as a cantilever spring, a leaf spring, a helical spring, a coil spring, a volute spring, a compression spring, a tension spring or a torsion spring, for example.

The spring element 412 may be formed of any suitable material, such as stainless steel, for example.

In a non limiting example, the spring element 412 may comprise a helical compression spring with any suitable stiffness or rate. In a non-limiting example the stiffness may be in the range of approximately 35-50 N/mm.

A helical compression spring may be commercially available by the SPEC® company under the catalogue number D23800, with a stiffness of 39.84 N/mm.

The spring elements 412 may be welded to the circumferential pipe 120 at a first end 416 thereof and may be welded to the central pipe 126 at a second end thereof 418. In another embodiment, the spring elements 412 may be connected to the circumferential pipe 120 and the central pipe 126 in any suitable manner.

The connecting element 412 may be placed intermediate the central pipe 126 and the circumferential pipe 120 as shown in FIG. 4, or at any location along the annulus assembly.

In FIG. 5 an alternative coaxial pipe coupling assembly 404 is shown. As seen in FIG. 5, the coaxial pipe coupling assembly 404 comprises a flange assembly 420 and the connecting elements 410. The flange assembly 420 may be provided intermediate portions (similar to first and second portion 150 and 154 of FIGS. 1A-1D) of the annulus assembly 102 at desired junctions along the annulus assembly 102.

The flange assembly 420 may comprise a circumferential tube 424, formed to be inserted on the circumferential pipe 120 (FIGS. 1A-1D) or may be connected thereto in any suitable manner. From the circumferential tube 424 may protrude an annular circumferential flange 426 formed with a plurality of peripherally arranged bores 428.

The flange assembly 420 may also comprise a central tube 434, formed to be inserted on the central pipe 126 (FIGS. 1A-1D) or may be connected thereto in any suitable manner.

The connecting element 410 may be placed intermediate the central tube 434 and the circumferential tube 424. Connecting elements 410 may comprise a plurality of the spring elements 412 spaced apart from each other in the radial orientation of arrow 408.

The spring elements 412 may be welded to the circumferential tube 424 at the first end 416 thereof and may be welded to the central tube 434 at the second end thereof 418. In another embodiment, the spring elements 412 may be connected to the circumferential tube 434 and the central tube 424 in any suitable manner.

The flange assembly 420 may be coupled with a corresponding flange assembly (not shown) and may be connected to by inserting bolts (not shown) through bores 428.

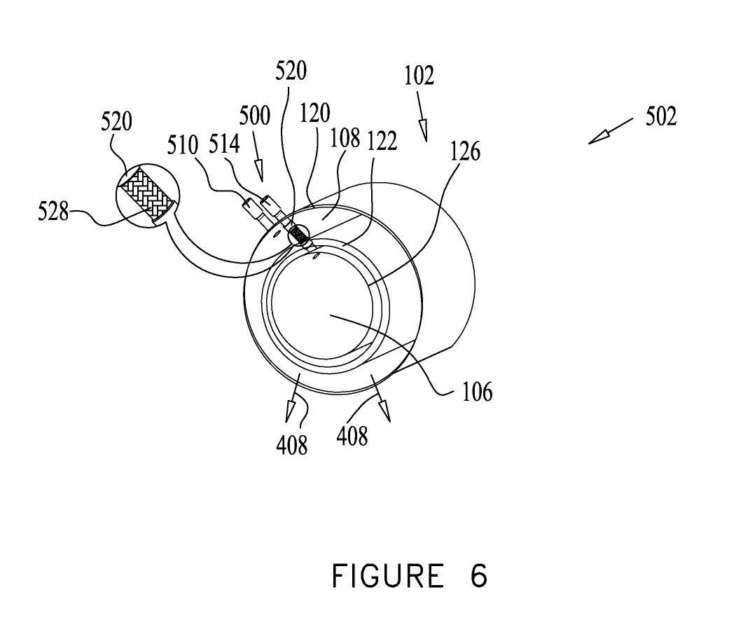

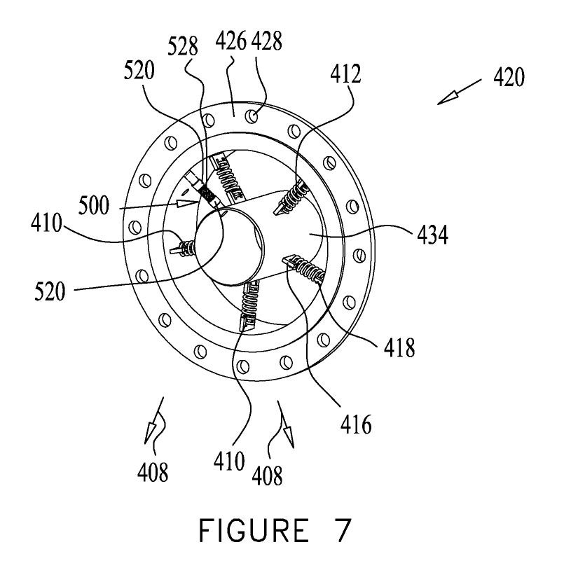

FIG. 6 and FIG. 7 are each a simplified pictorial illustration of a flexible housing assembly 500 according to an embodiment of the present disclosure. In FIG. 6, a fluid conduit system 502 comprising the flexible housing assembly 500 is shown engaged with the central pipe 126 and the circumferential pipe 120. In FIG. 7, the flexible housing assembly 500 is shown engaged with the flange assembly 420 of FIG. 5.

As seen in FIG. 6, sensors or other devices may be placed along the annulus assembly 102. The sensors or other devices may measure any parameter of interest, such as temperature, pressure and/or flow rate, for example. The sensors may comprise any conventional sensor, such as a thermocouple for measuring the temperature of the working fluid flowing within the central fluid channel 106 or the circumferential fluid channel 108.

For example, a first sensor 510 may be provided to measure the temperature of the working fluid flowing within the circumferential fluid channel 108. A second sensor 514 may be provided to measure the temperature of the working fluid flowing within the central fluid channel 106.

The first sensor 510 may protrude from the circumferential pipe 120. The second sensor 514 may protrude from the circumferential pipe 120 and extend to the central pipe 126 and may be housed within the flexible housing assembly 500.

As described above, the central pipe 126 may thermally expand along the radial axis 110 in the orientation of arrows 408. The central pipe 126 may thermally expand to a greater degree or a different degree than the circumferential pipe 120.

The flexible housing assembly 500 may comprise a tube comprising a flexible sensor tube 520. The flexible sensor tube 520 is configured of any suitable flexible material and/or configuration for flexibly extending in the orientation of arrow 408, thereby extending in tandem with the expansion of the central pipe 126 in the radial orientation of arrows 408.

In an embodiment, the flexible sensor tube 520 may comprise a cylindrical sheath 528 for providing flexibility to the flexible sensor sleeve 520. The cylindrical sheath 528 may be formed as a braided sheath, as seen in the insert in FIG. 6. The flexible sensor tube 520 may be formed of any suitable material such as stainless steel.

The flexible sensor tube 520 may be formed of any suitable flexible material with any suitable stiffness or rate. In a non-limiting example the flexible sensor tube 520 may be formed of a material with a material flexibility measured by a minimum bend radius in the range of approximately 0.2-70 inches.

It is known in the art that a “bend radius” or “minimum bend radius”, which is measured to the inside curvature of a tube, measures the minimum radius the tube can be bent while remaining undamaged and is thus an indication of the material flexibility. Typically, the smaller the bend radius, the greater is the material flexibility.

The flexible sensor tube 520 comprising the cylindrical sheath 528 may be commercially available by US Hose Corporation of 815 Forestwood Drive, Romeoville, Ill., USA, under the catalogue number “T321 stainless steel hose”.

The flexible sensor tube 520 may be connected to the central pipe 126 and the circumferential pipe 120 in a suitable manner, such as by welding the flexible sensor tube 520 to the central pipe 126 and the circumferential pipe 120, for example.

In FIG. 7 the flexible housing assembly 500 is shown engaged with the flange assembly 420 of FIG. 5.

It is noted that the flexible housing assembly 500 may be operative to flexibly extend in the orientation of the radial axis 110. Additionally the flexible housing assembly 500 may be configured to extend in the orientation of the longitudinal axis 140. In the embodiment of FIGS. 6 and 7 the flexible sensor tube 520 including the cylindrical sheath 528 may extend in the orientation of both the radial axis 110 and the longitudinal axis 140.

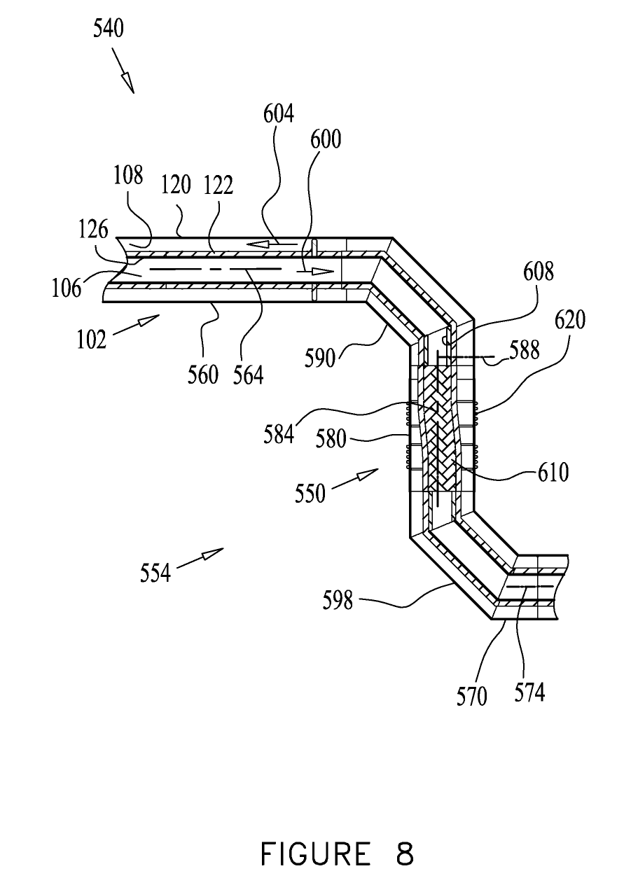

FIG. 8 is a simplified sectional illustration of a fluid conduit system 540 comprising the annulus assembly 102 and a flexible pipe assembly 550 according to an embodiment of the present disclosure. The flexible pipe assembly 550 may be utilized within the annulus assembly 102.

As described above, the annulus assembly 102 may be relatively long. The annulus assembly 102 may comprise a plurality of pipe subassemblies 554 which may be positioned at different orientations. For example, as seen in FIG. 8, a first pipe subassembly 560 may be positioned with a generally horizontal longitudinal axis 564.

A second pipe subassembly 580 may connect the first pipe subassembly 560 to a third pipe subassembly 570. The second pipe subassembly 580 may be positioned with a longitudinal axis 584 and a radial axis 588. The longitudinal axis 584 is substantially perpendicular to the orientation of longitudinal axis 564. An intermediate pipe subassembly 590 may connect the first pipe subassembly 560 with the second pipe subassembly 580. An additional intermediate pipe subassembly 598 may connect the third pipe subassembly 570 with the second pipe subassembly 580.

The pipe subassemblies 554 may be connected to each other by any suitable means, such as by welding the pipe subassemblies 554 to each other, for example.

In the example shown in FIG. 8, the working fluid may flow within central fluid channel 106, in the orientation of an arrow 600, from first pipe subassembly 560 to the third pipe subassembly 570, via substantially perpendicular second pipe subassembly 580 and intermediate pipe subassemblies 590 and 598. The working fluid may flow within circumferential fluid channel 108 in the opposite orientation, as illustrated by an arrow 604, from third pipe subassembly 570 to the first pipe subassembly 560, via substantially perpendicular, second pipe subassembly 580 and intermediate pipe subassemblies 598 and 590.

It is noted that in accordance with an embodiment, the flow orientation may be in the opposite orientation to the orientation shown in FIG. 8, i.e. the working fluid may flow within the circumferential fluid channel 108 in the orientation of arrow 600 and the working fluid may flow within the central fluid channel 106 in the orientation of arrow 604. Alternatively, in both the central fluid channel 106 and the circumferential fluid channel 108 the working fluid may flow the orientation of arrow 600 or 604.

As described above, the central pipe 126 and the circumferential pipe 120 may thermally expand along both the longitudinal axis 140 and the radial axis 110 (FIG. 1A). Accordingly, the thermal expansion of the central pipe 126 along a longitudinal axis (such as axis 140 of FIG. 1A) of a given pipe subassembly may exert a force along a radial axis (such as axis 110 of FIG. 1A) of another perpendicularly positioned pipe subassembly. This can be seen in FIG. 8, wherein the thermal expansion along the longitudinal axis 564 of the first pipe subassembly 560 may exert a force on the perpendicularly positioned second pipe subassembly 580 along the radial axis 588 thereof.

In accordance with an embodiment, the central pipe 126 at the second pipe subassembly 580 may comprise the flexible pipe assembly 550. The flexible pipe assembly 550 is designed to flexibly extend in the orientation of the radial axis 588, in tandem with the thermal expansion of the central pipe 126 of the first pipe subassembly 560, thereby preventing the breakage of the central pipe 126 of the second pipe subassembly 580, had the central pipe 126 been formed of a rigid material.

The flexible pipe assembly 550 may comprise a tube 608 including a cylindrical sheath 610 for providing flexibility to the flexible pipe assembly 550. The cylindrical sheath 610 may be formed as a braided sheath, as seen in FIG. 8. The flexible pipe assembly 550 may be formed of any suitable material, such as stainless steel.

The cylindrical sheath 610 may be commercially available by US Hose Corporation of 815 Forestwood Drive, Romeoville, Ill., USA, under the catalogue number “T321 stainless steel hose” and may comprise a minimal bend radius of 16.5 inches (measuring the static bend).

As described in reference to FIGS. 1A-1D, in some embodiments the central pipe 126 of at least one of the pipe subassemblies 554 may be formed of the central thermal insulation layer 122 such that the working fluid may flow in direct contact with an inner interior surface 128 of the central thermal insulation layer 122. In this embodiment the flexible pipe assembly 550 may be formed of any suitable material, such as a metal, such as stainless steel, or may be formed of a flexible and thermally insulating material.

The flexible pipe assembly 550 may be connected to the central pipe 126 of the intermediate pipe subassemblies 590 and 598 in a suitable manner, such as by welding the tube 608 thereto.

It is noted that the flexible pipe assembly 550 may be operative to flexibly extend in the orientation of the radial axis 588. Additionally the flexible pipe assembly 550 may be configured to extend in the orientation of the longitudinal axis 564.

It is further noted that the flexible pipe assembly 550 may be utilized for any first portion of the annulus assembly 102 (e.g. the first pipe subassembly 560) and second portion of the annulus assembly 102 (e.g. the second pipe subassembly 580), which are unparallel to each other.

Bellows 620 may be provided around the circumferential pipe 120 of the second pipe subassembly 580, or any other suitable location, for absorbing the thermal expansion of circumferential pipe 120 due to flow of the working fluid within the circumferential fluid channel 108.

In the embodiments described above in FIGS. 1A-8 the central pipe 126 may thermally expand in the radial axis 110 or longitudinal axis 140 to a greater degree than the circumferential pipe 120. In accordance with an embodiment of the present disclosure, apparatus are provided to ensure the coaxial alignment between the central fluid channel 106 and the circumferential fluid channel 108 is substantially maintained and/or preventing damage to the central pipe 126. The apparatus may include, inter alia, the pipe adjoining assembly 170 of FIGS. 1A-2; the pipe adjoining assembly 310 of FIGS. 3A-3C; the coaxial pipe coupling assembly 400 of FIG. 4; the coaxial pipe coupling assembly 404 of FIG. 5; the flexible housing assembly 500 of FIGS. 6 and 7 and the flexible pipe assembly 550 of FIG. 8.

In accordance with another embodiment these apparatus may be utilized wherein the central pipe 126 thermally expands in the radial axis 110 or longitudinal axis 140 to a same or lesser or different degree than the circumferential pipe 120.

In accordance with another embodiment these apparatus may be utilized wherein a first fluid flows within the central fluid channel 106 and a second, different fluid flows within the circumferential fluid channel 108.

In accordance with another embodiment the apparatus may be utilized to ensure the coaxial alignment between any central pipe and circumferential pipe and/or prevent damage thereof, such as pipe assemblies used for flow of electricity or optics any other suitable use.

It is noted that the thermal expansion along axis 110 and along axis 140, described throughout the disclosure may refer to the linear thermal expansion.

It is further noted that the term “flexibly extend” or the like used in the present disclosure may comprise both extension and contraction.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

What is claimed is:

1. A fluid conduit system comprising:
a first portion comprising a central pipe and a circumferential pipe surrounding the central pipe and coaxially aligned with the central pipe along a radial axis thereof;
a second portion comprising a central pipe and a circumferential pipe surrounding the central pipe along the radial axis;
the first portion being aligned with the second portion in the radial axis; and
a tube configured for housing the central pipe of the first portion and the central pipe of the second portion therein, at a longitudinal distance between the central pipe of the first portion and the central pipe of the second portion, along a longitudinal axis thereof.

2. A fluid conduit system according to claim 1 wherein the tube is surrounded by a sealing element.

3. A fluid conduit system according to claim 2 wherein the sealing element comprises a cord.

4. A fluid conduit system according to claim 3 wherein the cord is formed with a substantially rectangular cross section.

5. A fluid conduit system according to claim 1 wherein a working fluid flows within the central pipe of at least one of the first portion and second portion, at a first temperature, and the working fluid flows within the circumferential pipe of at least one of the first portion and second portion, at a second temperature, and the first temperature is different than the second temperature.

6. A fluid conduit system according to claim 5 wherein the first temperature is higher than the second temperature and the central pipe of at least one of the first portion and second portion thermally expands along the longitudinal distance.

7. A fluid conduit system according to claim 1 wherein the central pipe of at least one of the first portion and second portion thermally expands to a different degree than the thermal expansion of the circumferential pipe of at least one of the first portion and second portion.

8. A fluid conduit system according to claim 1 wherein the central pipe of the second portion is slidably inserted within the tube.

9. A fluid conduit system according to claim 1 and further comprising a thermal insulation layer intermediate the central pipe and the circumferential pipe.

10. A fluid conduit system according to claim 1 wherein the central pipe is formed of a thermal insulating layer.

11. A fluid conduit system according to claim 1 wherein the first portion and the second portion are connected thereto by a connection configured for repeated assembling and disassembling of the connection.

12. A fluid conduit system according to claim 1 wherein a flexible connecting element connects the central pipe to the circumferential pipe.

13. A fluid conduit system according to claim 12 wherein the flexible connecting element comprises at least one spring element.

14. A fluid conduit system comprising:
a central pipe and a circumferential pipe surrounding the central pipe and coaxially aligned with the central pipe along a radial axis thereof; and
a tube configured for housing at least a portion of a device therein and wherein the tube is placed intermediate the central pipe and the circumferential pipe, the tube being configured for flexibly extending along the radial axis.

15. A fluid conduit system according to claim 14 wherein the tube comprises a cylindrical sheath formed as a braided sheath.

16. A fluid conduit system according to claim 14 wherein the tube is formed of a material with a material flexibility comprising a minimum bend radius in the range of approximately 0.2-70 inches.

17. A fluid conduit system according to claim 14 wherein the device comprises a sensor.

18. A fluid conduit system according to claim 14 wherein a working fluid flows within the central pipe at a first temperature and the working fluid flows within the circumferential pipe at a second temperature, and the first temperature is different than the second temperature.

19. A fluid conduit system according to claim 18 wherein the first temperature is higher than the second temperature.

20. A fluid conduit system according to claim 14 wherein the central pipe thermally expands to a different degree than the thermal expansion of the circumferential pipe.

21. A fluid conduit system according to claim 14 and further comprising a thermal insulation layer intermediate the central pipe and the circumferential pipe.

22. A fluid conduit system according to claim 14 wherein the central pipe is formed of a thermal insulating layer.

23. A fluid conduit system comprising:
a first portion comprising a central pipe and a circumferential pipe surrounding the central pipe and coaxially aligned with the central pipe along a radial axis thereof;
a second portion comprising a central pipe and a circumferential pipe surrounding the central pipe along a radial axis thereof;
the first portion being unparallel to the second portion along a longitudinal axis of the first portion; and
the central pipe of the second portion including a tube configured for flexibly extending along the radial axis and/or the longitudinal axis of the tube.

24. A fluid conduit system according to claim 23 wherein the first portion is substantially perpendicular to the second portion.

25. A fluid conduit system according to claim 23 wherein the tube comprises a cylindrical sheath formed as a braided sheath.

26. A fluid conduit system according to claim 23 wherein the tube is formed of a material with a material flexibility comprising a minimum bend radius in the range of approximately 0.2-70 inches.

27. A fluid conduit system according to claim 23 wherein a working fluid flows within the central pipe of at least one of the first portion and second portion, at a first temperature, and the working fluid flows within the circumferential pipe of at least one of the first portion and second portion, at a second temperature, and the first temperature is different than the second temperature.

28. A fluid conduit system according to claim 27 wherein the first temperature is higher than the second temperature and the central pipe of at least one of the first portion and second portion thermally expands along the longitudinal axis.

29. A fluid conduit system according to claim 23 and further comprising a thermal insulation layer intermediate the central pipe and the circumferential pipe of at least one of the first portion and second portion.

30. A fluid conduit system according to claim 23 wherein the central pipe of at least one of the first portion and second portion is formed of a thermal insulating layer.
